(19) United States
(12) Patent Application Publication
(10) Pub. No.: US 2024/0344547 A1
(43) Pub. Date: Oct. 17, 2024

(54) SCREW FASTENERS

(71) Applicants: Michael Wire, Auburn, CA (US); Daniel Riordan Smith, Venice, CA (US)

(72) Inventors: Michael Wire, Auburn, CA (US); Daniel Riordan Smith, Venice, CA (US)

(21) Appl. No.: 18/625,278

(22) Filed: Apr. 3, 2024

Related U.S. Application Data
(60) Provisional application No. 63/459,158, filed on Apr. 13, 2023.

(51) Int. Cl. F16B 25/00; E05B 3/00; E06B 9/00; E06B 9/02; F16B 23/00; F16B 37/14; F16B 39/282; H02S 20/23

(52) U.S. Cl. CPC F16B 25/0057; F16B 23/003; F16B 25/0073; F16B 39/282; H02S 20/23; E05B 3/00; E06B 2009/005; E06B 9/02; F16B 37/14

(57) ABSTRACT

Screw fasteners are disclosed that are configured to be inserted into a variety of solid substrates, which include a bottom end that is configured to be inserted into a solid substrate and a top end that is configured to be connected to various other parts and devices. The screw fasteners include a cylindrical inner core; at least one circular flange that surrounds the cylindrical inner core; a screw thread that is helically formed around the external surface of the bottom region of the screw; and a bolt thread that is helically formed around the external surface of the top region of the screw. The pitch of the bolt thread is smaller than the pitch of the screw thread. In addition, the minor diameter and/or major diameter of the bolt thread may be greater (or smaller) than the minor diameter and/or major diameter of the screw thread.

### CROSS-REFERENCE TO RELATED APPLICATIONS

This application claims priority to, and incorporates by reference, U.S. provisional patent application Ser. No. 63/459,158, filed on Apr. 13, 2023.

### FIELD OF THE INVENTION

The field of the present invention relates to mechanical fasteners. More specifically, the field of the present invention relates to unique screw fasteners, and particularly improved screw fasteners that are designed to be inserted into a variety of solid substrates, with such screw fasteners exhibiting a top threaded end that is configured to be connected to other correspondingly threaded parts and devices.

### BACKGROUND OF THE INVENTION

Male and female threaded fasteners, such as bolts and screws, are used in a variety of applications today, most often to connect and secure two or more pieces or items together. Indeed, for many years, male and female threaded fasteners have been used in residential and commercial building construction, complex machine construction, and many other industries and applications. With some applications, it is desirable to secure a screw or other fastener to a solid substrate, for purpose of providing an immobilized anchor to then attach another part or device to the solid substrate (with the screw or other fastener serving as the intermediary piece that connects such other part or device to the solid substrate). Non-limiting examples of such applications include the use of certain types of fasteners for securing a knob to the front of a drawer; securing a solar panel to a roof; securing a hurricane/storm (weather) screen to the outside of a window; and many others.

Although screws and other mechanical connectors have been developed over the years for such applications, the currently-available connectors are often difficult to install and/or use for such applications. Accordingly, there continues to be a demand in the marketplace for improved mechanical fasteners, and particularly for improved screw fasteners that are adapted to be inserted into a variety of substrates and which provide a top end that may be easily connected to other parts and devices.

As the following will demonstrate, the invention described herein addresses such demands in the marketplace (as well as others).

### SUMMARY OF THE INVENTION

According to certain aspects of the present invention, screw fasteners are provided that are configured to be inserted into a variety of solid substrates. The screw fasteners include a bottom end that is configured to be inserted into a solid substrate and a threaded top end that is configured to be connected to various other parts and devices. More specifically, the screw fasteners of the present invention include a cylindrical inner core and at least one circular flange that surrounds the cylindrical inner core and, in certain embodiments, separates the top region and bottom region of the screw fastener. In addition, the fasteners include a screw thread that is helically formed around the external surface of the bottom region of the cylindrical inner core—and a bolt thread that is helically formed around the external surface of the top region of the cylindrical inner core.

The invention provides that the pitch of the bolt thread is smaller than the pitch of the screw thread (i.e., the bolt thread includes a greater number of threads over a defined distance compared to the screw thread). In addition, in some embodiments, the invention provides that the minor diameter and/or the major diameter of the bolt thread is greater than the minor diameter and/or major diameter of the screw thread, meaning that the diameter of the top region is generally larger (thicker) than the diameter of the bottom region. In other embodiments, the minor diameter and/or the major diameter of the bolt thread is smaller than (or the same, or approximately the same, as) the minor diameter and/or major diameter of the screw thread. As described below, whether the bolt thread should exhibit a diameter that is greater, smaller, or the same as the diameter of the screw thread depends on how the screw fastener is being used. The screw fasteners of the present invention further include a pointed bottom end that is configured to be rotated into and penetrate a solid substrate, and a top end that includes a bit receptor that is configured to receive a correspondingly dimensioned screwdriver bit.

According to additional aspects of the present invention, various methods and applications for using the screw fasteners of the present invention are provided. For example, the invention encompasses methods of using the screw fasteners described herein for securing a knob to a drawer surface; methods for securing a hurricane/storm (weather) screen to a window; methods for securing a solar panel to a roof surface; and many other applications and methods of use.

The above-mentioned and additional features of the present invention are further illustrated in the Detailed Description contained herein.

### BRIEF DESCRIPTION OF THE DRAWINGS

FIG. 1 is a perspective view of a screw fastener of the present invention.

FIG. 2 is a front view of the screw fastener of FIG. 1.

FIG. 3 is a back view of the screw fastener of FIG. 1.

FIG. 4 is a left side view of the screw fastener of FIG. 1.

FIG. 5 is a right side view of the screw fastener of FIG. 1.

FIG. 6 is a top view of the screw fastener of FIG. 1.

FIG. 7 is a bottom view of the screw fastener of FIG. 1.

FIG. 8 is a diagram of a nut that may be used with the screw fasteners described herein.

FIG. 9 is a diagram of a cap that may be used with the screw fasteners described herein.

FIG. 10 is a diagram of several functional caps that may be used with the screw fasteners described herein.

FIG. 11 is a disassembled side view of another screw fastener of the present invention, which includes two circular flanges.

FIG. 12 is a perspective view of the screw fastener of FIG. 11.

FIG. 13 is a cross-sectional view of a screw fastener described herein being connected to a drawer knob.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used, and made without departing from the scope and spirit of the invention.

### Definitions

The following terms shall be interpreted in view of the definitions ascribed to such terms below.

The term “axis” refers to the longitudinal central line through the screw.

The term “crest” refers to the surface of the thread corresponding to the major diameter.

The term “major diameter” refers to the largest diameter of the thread, also known as the “outside diameter” or “full diameter.”

The term “minor diameter” refers to the smallest diameter of the thread, also known as the “core diameter” or “inside diameter.”

The term “pitch” refers to the distance from a point on a screw thread to a corresponding point on the next thread measured parallel to the axis of the screw, e.g., measured between the crests of adjacent threads.

The term “pitch in inches” means 1 divided by the number of threads per inch.

The term “screw thread” refers to the helix formed around the external surface of the interior cylinder that forms the screw.

The term “root” refers to the surface of the thread corresponding to the minor diameter.

### Description

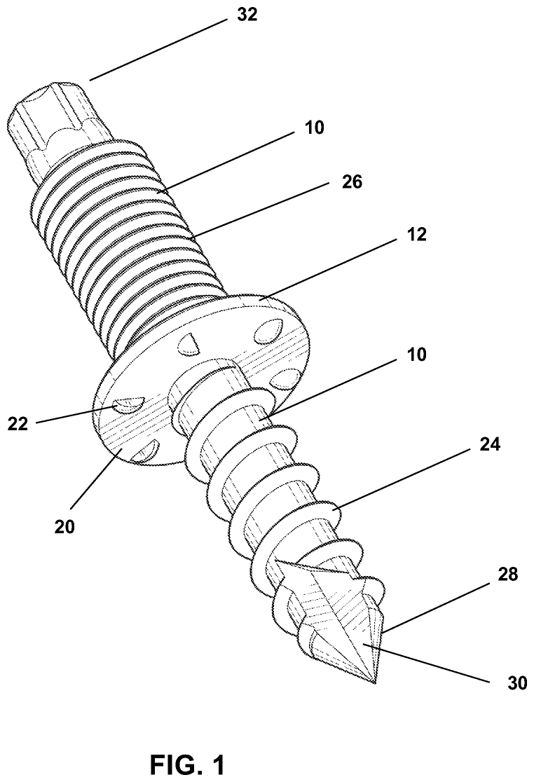

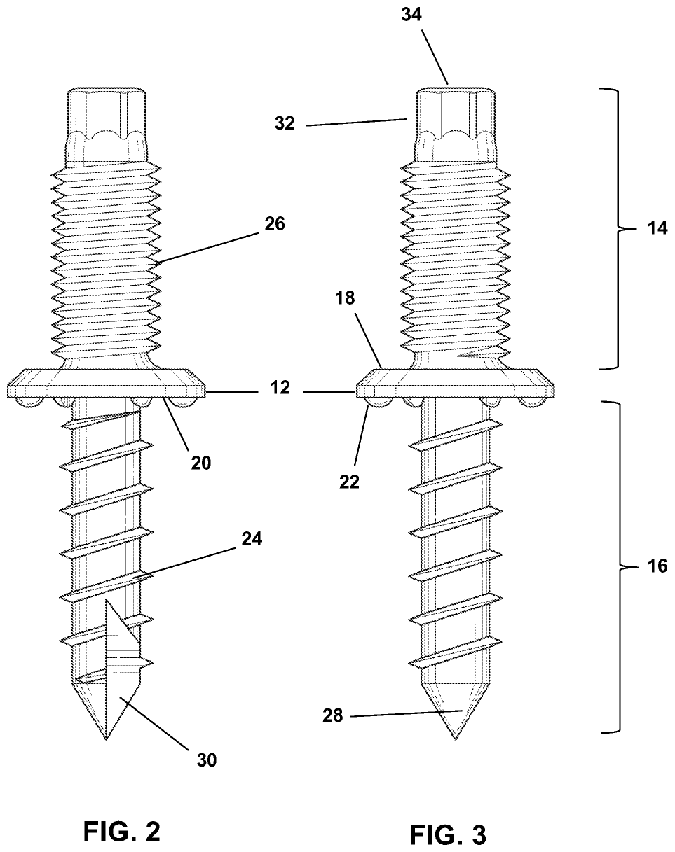

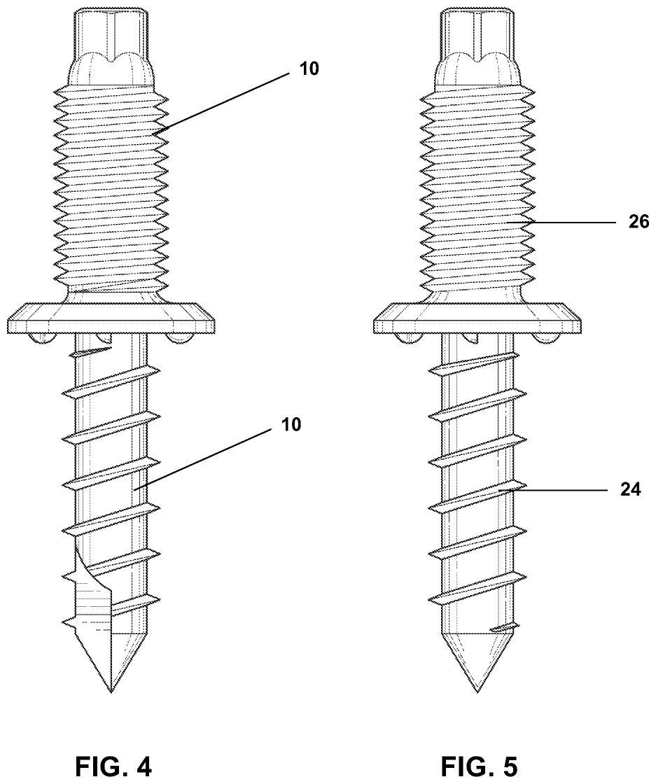

Referring now to FIGS. 1-13, according to certain preferred embodiments of the present invention, screw fasteners are provided that are configured to be inserted into a variety of solid substrates. According to certain preferred embodiments of the present invention, the screw fasteners include a cylindrical inner core 10, through which the axis of the screw fastener is located. In addition, the screw fasteners of the present invention include at least one circular flange 12 that surrounds the cylindrical inner core 10. For those embodiments having a single circular flange 12, the circular flange 12 separates the screw fastener into a top region 14 and a bottom region 16 (FIG. 3). The invention provides that the circular flange 12 may exhibit a variety of shapes, sizes, and dimensions, e.g., relative to the bottom surface 20 of the flange 12, the circular flange 12 may exhibit a beveled surface, a concave surface, a convex surface, two straight/non-beveled surfaces, and others.

According to certain preferred embodiments, the invention provides that the circular flange 12 includes a top surface 18 and, as mentioned above, a bottom surface 20, with the bottom surface 20 optionally comprising a plurality of locking nibs 22 that protrude from the bottom surface 20. In certain embodiments, the locking nibs 22 will exhibit a hemispherical shape—and, optionally, may include a concave inner surface. The invention provides that the presence and location of the locking nibs 22 serve to facilitate immobilizing the screw fastener within a solid substrate. In addition, the locking nibs 22 may further serve to discourage the screw from rotating in a loosening manner when another part or device (e.g., a drawer handle) is being rotated around and connected to the bolt thread 26 (described below). More specifically, as described further below, when the screw fastener is rotated into and penetrates a solid substrate, the screw fastener is rotated until the bottom surface 20 of the circular flange 12 makes contact with the solid substrate, thereby allowing the locking nibs 22 to also penetrate the substrate and further immobilize the screw fastener therein. The invention provides that the bottom surface 20 of the circular flange 12 may include one or multiple locking nibs 22.

The screw fasteners of the present invention further include a screw thread 24 that is helically formed around an external surface of the bottom region 16 of the cylindrical inner core 10. In addition, the screw fasteners of the present invention include a bolt thread 26 that is helically formed around an external surface of the top region 14 of the cylindrical inner core 10. Importantly, in certain embodiments, the invention provides that the pitch of the bolt thread 26 is smaller than the pitch of the screw thread 24. In other words, more precisely, the pitch in inches of the bolt thread 26 is smaller than the pitch in inches of the screw thread 24. In certain embodiments, the bolt thread 26 may include at least two-times (2X) a number of threads within a defined length (e.g., within 0.5 inches) than a number of threads of the screw thread 24 over the same defined length.

In certain embodiments, the invention further provides that the minor diameter and/or the major diameter of the bolt thread 26 is greater than the minor diameter and/or major diameter of the screw thread 24, respectively. In other words, in those embodiments, the bolt thread 26 of the top region 14 will preferably be thicker than the screw thread 24 of the bottom region 16. The invention provides that such configuration enables the screw fastener to easily and securely penetrate a solid substrate, while limiting the aperture (hole) created or required by the bottom region 16 when the screw thread 24 is rotated into the substrate. In addition, such configuration increases the overall thickness of the bolt thread 26 of the top region 14, which provides a more formidable anchor on which to connect other items and devices.

Alternatively, in other embodiments, the minor diameter and/or the major diameter of the bolt thread 26 is smaller than the minor diameter and/or major diameter of the screw thread 24, i.e., the top region 14 will be thinner than the bottom region 16. In still other embodiments, the minor diameter and/or the major diameter of the bolt thread 26 may be the same, or approximately the same, as the minor diameter and/or major diameter of the screw thread 24. To clarify, when the present specification refers to comparing the major diameters and minor diameters of the top region 14 and bottom region 16, it should be understood that the major diameter of the top region 14 should be compared to the major diameter of the bottom region 16 and, similarly, the minor diameter of the top region 14 should be compared to the minor diameter of the bottom region 16. The invention provides that each of the foregoing embodiments and configurations may be more suitable than others for a particular application.

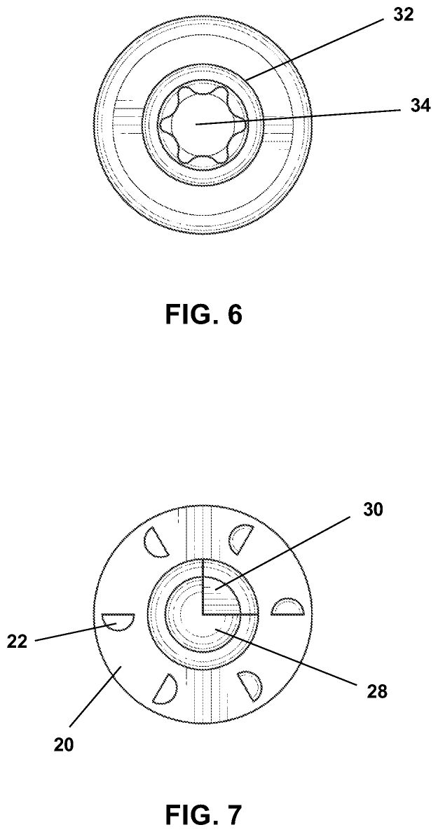

The screw fasteners of the present invention further include a pointed bottom end 28 that is configured to be rotated into and penetrate a solid substrate. The pointed bottom end 28 may, optionally, include a cutout region 30 that facilitates the ability of the pointed bottom end 28 to penetrate and rotate through a solid substrate. In addition, the screw fasteners of the present invention include a top end 32 that includes a bit receptor 34 (FIG. 6) that is configured to receive a correspondingly dimensioned screwdriver bit. The invention provides that the bit receptor 34 may be configured to receive any of a variety of screwdriver bits, such as flat heads, Phillips heads, Allen wrench heads, or others. In certain preferred embodiments, the bit receptor 34 consists of a hexalobular drive receptor. Still further, the invention provides that certain screw fasteners of the present invention may be designed to penetrate a drywall surface, in which case the screw fastener may further comprise an expanding/locking anchor within the bottom region 16 of the screw fastener (which expands upon insertion of the screw fastener through the drywall surface, to further stabilize the screw fastener to the drywall surface).

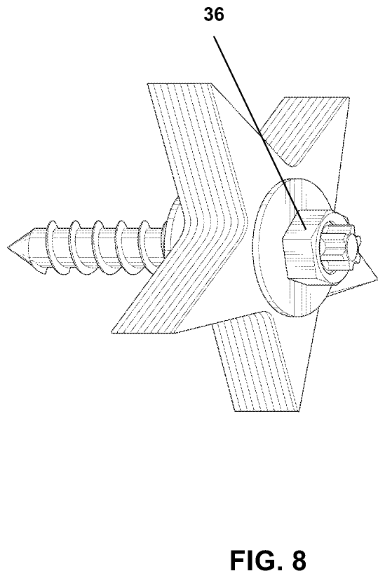

Still further, in certain embodiments, the screw fasteners of the present invention may include an optional nut 36 (FIG. 8). In such embodiments, the nut 36 is preferably configured as a Keps nut, i.e., a nut 36 with an attached or integrally formed washer piece that is adapted to be rotated around and secured to the bolt thread 26 of the screw fastener. The nut 36 may be used in specific applications of the screw fasteners, such as those described below to connect, for example, a hurricane/storm (weather) screen to an exterior area of a window or a solar panel to a roof surface.

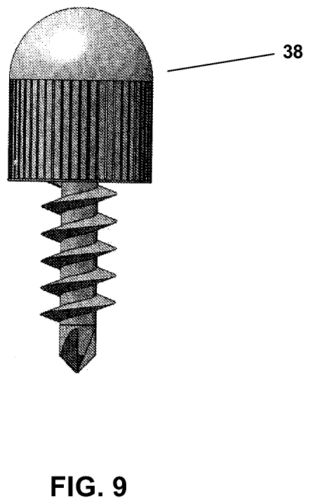

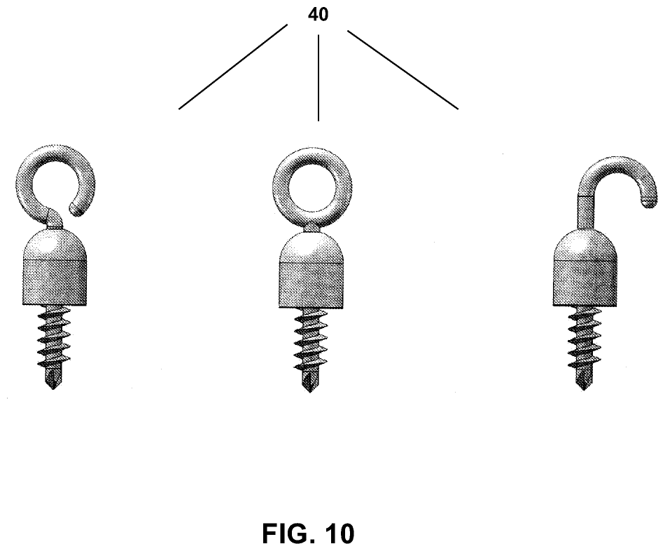

In other embodiments, the screw fasteners may include a cap 38 (FIG. 9) that may be used primarily for aesthetic purposes, e.g., to cover the top end 32 of a screw fastener that has been immobilized within a solid substrate, but is not otherwise being used to connect another part or device to the top region 14 of the screw fastener. In such embodiments, the cap 38 may comprise a convex top surface (to hide the top end 32 of a screw fastener), with the bottom surface/interior area of the cap 38 having a female threaded aperture that is dimensioned to receive the bolt thread 26. Referring now to FIG. 10, the screw fasteners may also include a functional cap 40, i.e., a functional cap 40 that may be applied to the top region 14 of the screw fastener in a similar manner as the decorative cap 38 described above, but instead has a hook, loop, or other element integrally formed with the functional cap 40 that may be used for specific applications.

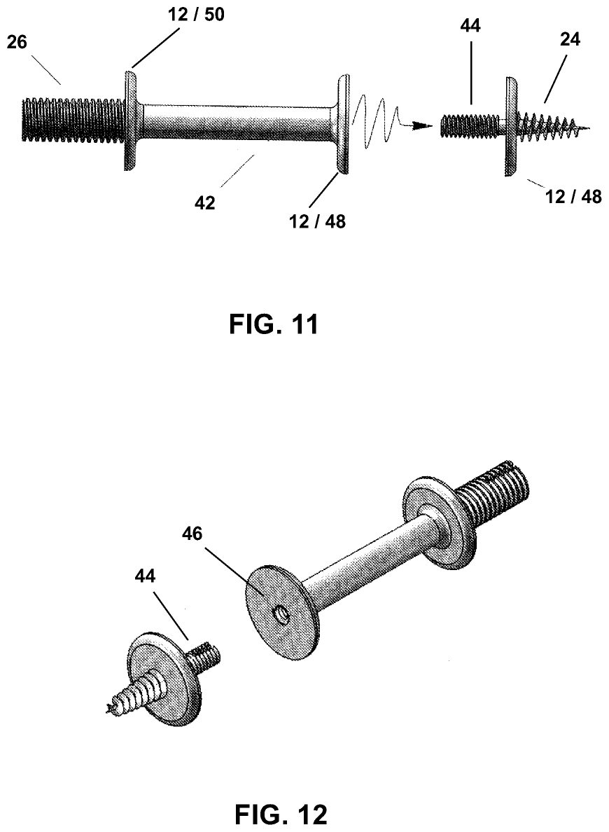

Referring now to FIGS. 11 and 12, according to yet further embodiments of the present invention, the screw fasteners may include two separate circular flanges 12. In some cases, it may be desirable to maintain a certain amount of space between the surface of a solid substrate and another part/device that is connected to the screw fastener. In such cases, a screw fastener that includes two separate circular flanges 12 may be optimal. In such embodiments, the screw fasteners may include a first circular flange 12/48 positioned near the screw thread 24 and a second circular flange 12/50 positioned near the bolt thread 26, which creates a spacer region 42 between the first circular flange 12/48 and second circular flange 12/50.

In such embodiments, the screw thread 24 of the screw fastener may be inserted into and immobilized within a solid substrate until the first circular flange 12/48 is flush with the surface of the solid substrate. The desired device or part may be connected to the bolt thread 26 as described herein (up to the surface of the second circular flange 12/50, which thereby maintains a defined and consistent space (the spacer region 42 of the screw fastener) between the connected device or part and the surface of the solid substrate. In such embodiments, the second circular flange 12/50 will serve as a seat that further supports the device or part that is connected to the bolt thread 26. The invention provides that the screw fasteners of such embodiments may exist as an integrated/single-piece screw fastener. Alternatively, the screw fasteners of such embodiments may exist as two separate pieces that may be connected to each other at, for example, the first circular flange 12/48 through a threaded male part 44 and correspondingly dimensioned/threaded aperture 46 (FIG. 12).

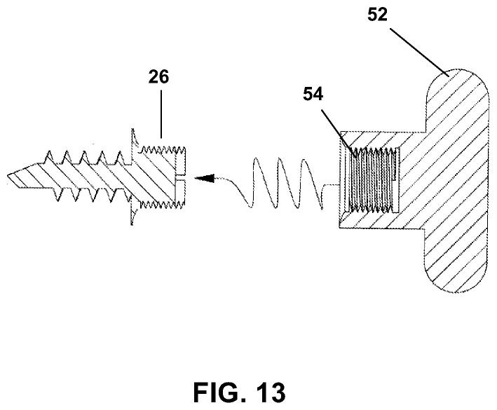

As mentioned above, there are many applications and methods of using the screw fasteners of the present invention. For example, the screw fasteners may be used for securing a knob to a door surface. Referring now to FIG. 13, according to such methods, the screw thread 24 is rotated and inserted into the door surface until the circular flange 12 is at least flush with the door surface, preferably such that the locking nibs 22 also penetrate the surface of the substrate to assist in further immobilizing the screw fastener. Next, the knob 52 may be connected to the top region 14 of the screw fastener, e.g., by inserting the bolt thread 26 of the top region 14 into a correspondingly threaded female aperture 54 of the knob 52.

In other embodiments, the screw fasteners may be used for securing a hurricane/storm (weather) screen to an exterior area of a window. Such methods involve rotating the screw threads 24 of multiple screw fasteners into different locations of a surface that surrounds and is adjacent to the window—until the circular flange 12 is at least flush with the exterior area of the window. For example, a plurality of the screw fasteners may be inserted around the perimeter of the window. Next, the hurricane/storm screen may be connected to the top regions 14 of the screw fasteners, by inserting the bolt threads 26 through apertures located around the perimeter of the hurricane/storm (weather) screen. Finally, the hurricane/storm (weather) screen may be secured in place, by attaching a nut 36 and/or cap 38 to each of the top regions 14 of the screw fasteners that extend beyond the apertures located around the perimeter of the hurricane/storm (weather) screen.

Similarly, the screw fasteners may be used for securing a solar panel to a roof. Such methods are carried out by first rotating the screw threads 24 of multiple screw fasteners into different locations of a roof surface, until the circular flange 12 is at least flush with the roof surface. The screw fasteners should be installed at positions that correspond with apertures located around the perimeter of the solar panel. Next, the solar panel is connected to the top regions 14 of the screw fasteners, by inserting the bolt threads 26 through such corresponding apertures located around the perimeter of the solar panel. Finally, the solar panel is locked in place by attaching a nut 36 and/or cap 38 to each of the top regions 14 of the screw fasteners.

The invention provides that the screw fasteners described herein may be comprised of any suitably rigid materials, such as steel, iron, titanium, plastics, and other materials. The screw fasteners may be manufactured through well-known methods, such as reciprocating die methods, extrusion methods, casting methods, machining procedures, injection molding procedures, 3D digital printing, and others.

### Examples

The following provides a series of non-limiting examples of the screw fasteners of the present invention. The following examples are intended to describe certain non-limiting and non-exhaustive embodiments of the present invention. All dimensions referenced below are expressed in inches.

Example-1 (Knob Fastener)

| | |
|---|---|
| Total Length | 1.035 |
| Length of Upper Region | 0.335 |
| Length of Lower Region | 0.655 |
| Major Diameter of Upper Region | 0.1631 |
| Major Diameter of Lower Region | 0.196 |
| Minor Diameter of Upper Region | 0.142 |
| Minor Diameter of Lower Region | 0.102 |
| Diameter of Flange | 0.281 |
| Upper Region Thread Count | 14 |
| Lower Region Thread Count | 7 |
| Bit Receptor | 6-Lobe Driver |

Example-2 (Standard (10-24))

| | |
|---|---|
| Total Length | 2.360 |
| Length of Upper Region | 0.610 |
| Length of Lower Region | 1.750 |
| Major Diameter of Upper Region | 0.189 |
| Major Diameter of Lower Region | 0.221 |
| Minor Diameter of Upper Region | 0.162 |
| Minor Diameter of Lower Region | 0.162 |
| Diameter of Flange | 0.510 |
| Upper Region Thread Count | 12 |
| Lower Region Thread Count | 7 |
| Bit Receptor | 6-Lobe Driver |

Example-3 (Standard ¼-20))

| | |
|---|---|
| Total Length | 2.725 |
| Length of Upper Region | 0.975 |
| Length of Lower Region | 1.750 |
| Major Diameter of Upper Region | 0.2408 |
| Major Diameter of Lower Region | 0.221 |
| Minor Diameter of Upper Region | 0.217 |
| Minor Diameter of Lower Region | 0.162 |
| Diameter of Flange | 0.510 |
| Upper Region Thread Count | 16 |
| Lower Region Thread Count | 7 |
| Bit Receptor | 6-Lobe Driver |

Example-4 (Weather Panel Applications 5/16-18)

| | |
|---|---|
| Total Length | 3.818 |
| Length of Upper Region | 1.200 |
| Length of Lower Region | 2.540 |
| Major Diameter of Upper Region | 0.3125 |
| Major Diameter of Lower Region | 0.209 |
| Minor Diameter of Upper Region | 0.276 |
| Minor Diameter of Lower Region | 0.162 |
| Diameter of Flange | 0.510 |
| Upper Region Thread Count | 16 |
| Lower Region Thread Count | 17 |
| Bit Receptor | 6-Lobe Driver |

As mentioned above, the Examples are intended to describe certain non-limiting and non-exhaustive embodiments of the present invention. The screw fasteners of the present invention are scalable, the dimensions of which can be tailored for a specific application. For example, the screw fasteners of the present invention may even be scaled on the order feet, e.g., a large screw fastener that incorporates the features described herein that may be manufactured to be 1, 2, 3, 4, or more feet in length (with the other features of such screw being proportionally dimensioned). A large format screw of the present invention may be used, for example, to tether a ship to a pier or other applications that require the use of a large format screw of this type.

The many aspects and benefits of the invention are apparent from the detailed description, and thus, it is intended for the following claims to cover all such aspects and benefits of the invention that fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

We claim:

1. A screw fastener that comprises:
(a) a cylindrical inner core;
(b) at least one circular flange that surrounds the cylindrical inner core and separates a top region and a bottom region of the screw fastener;
(c) a screw thread that is helically formed around an external surface of the bottom region of the cylindrical inner core;
(d) a bolt thread that is helically formed around an external surface of the top region of the cylindrical inner core, wherein a pitch of the bolt thread is smaller than a pitch of the screw thread;
(e) a pointed bottom end that is configured to be rotated into and penetrate a solid substrate; and
(f) a top end that includes a bit receptor, which is configured to receive a correspondingly dimensioned screwdriver bit.

2. The screw fastener of claim 1, wherein the circular flange includes a top surface and a bottom surface, wherein the bottom surface includes a plurality of locking nibs that protrude from the bottom surface.

3. The screw fastener of claim 2, wherein each of the locking nibs exhibits a hemispherical shape.

4. The screw fastener of claim 1, wherein (i) a minor diameter of the bolt thread is smaller than a minor diameter of the screw thread and/or (ii) a major diameter of the bolt thread is smaller than a major diameter of the screw thread.

5. The screw fastener of claim 1, wherein (i) a minor diameter of the bolt thread is greater than a minor diameter of the screw thread and/or (ii) a major diameter of the bolt thread is greater than a major diameter of the screw thread.

6. The screw fastener of claim 1, wherein the bolt thread includes at least 2× a number of threads within a defined length than a number of threads of the screw thread over the defined length.

7. The screw fastener of claim 1, wherein the bit receptor is a hexalobular drive receptor.

8. The screw fastener of claim 1, which further includes a nut with an attached washer piece that is adapted to be rotated around and secured to the top region of the screw fastener.

9. A screw fastener that comprises:
(a) a cylindrical inner core;
(b) at least one circular flange that surrounds the cylindrical inner core and separates a top region and a bottom region of the screw fastener, wherein the circular flange includes a top surface and a bottom surface, with the bottom surface comprising a plurality of locking nibs that protrude from the bottom surface, wherein each of the locking nibs exhibits a hemispherical shape;
(c) a screw thread that is helically formed around an external surface of the bottom region of the cylindrical inner core;
(d) a bolt thread that is helically formed around an external surface of the top region of the cylindrical inner core, wherein (i) a pitch of the bolt thread is smaller than a pitch of the screw thread; (ii) the bolt thread includes at least 2× a number of threads within a defined length than a number of threads of the screw thread over the defined length; and (iii) (y) a minor diameter and/or a major diameter of the bolt thread is greater than a minor diameter and/or a major diameter, respectively, of the screw thread or (z) the minor diameter and/or the major diameter of the bolt thread is smaller than the minor diameter and/or the major diameter, respectively, of the screw thread;
(e) a pointed bottom end that is configured to be rotated into and penetrate a solid substrate;
(f) a top end that includes a bit receptor that is configured to receive a correspondingly dimensioned screwdriver bit, wherein the bit receptor is a hexalobular drive receptor; and
(g) a nut with an attached washer piece that is adapted to be rotated around and secured to the top region of the screw fastener.

10. A method for securing a knob to a door surface, which comprises:
(a) rotating the screw thread of the screw fastener of claim 1 into the door surface until the circular flange is at least flush with the door surface; and
(b) attaching the knob to the top region of the screw fastener, by inserting the bolt thread of the top region into a correspondingly threaded female aperture of the knob.

11. A method for securing a hurricane/storm screen to an exterior area of a window, which comprises:
(a) rotating the screw threads of multiple screw fasteners of claim 1 into different locations of a surface that surrounds and is adjacent to the window until the circular flange is at least flush with the surface;
(b) attaching the hurricane/storm screen to the top regions of the screw fasteners, by inserting the bolt threads of the top regions through apertures located around a perimeter of the hurricane/storm screen; and
(c) attaching a nut to each of the top regions of the screw fasteners.

12. A method for securing a solar panel to a roof, which comprises:
(a) rotating the screw threads of multiple screw fasteners of claim 1 into different locations of a roof surface until the circular flange is at least flush with the roof surface;
(b) attaching the solar panel to the top regions of the screw fasteners, by inserting the bolt threads of the top regions through apertures located around a perimeter of the solar panel; and
(c) attaching a nut to each of the top regions of the screw fasteners.

13. A screw fastener that comprises:
(a) a cylindrical inner core;
(b) a first circular flange that surrounds the cylindrical inner core and a second circular flange that surrounds the cylindrical inner core, with a spacer region located between the first circular flange and second circular flange;
(c) a screw thread that is helically formed around an external surface of a bottom region of the cylindrical inner core;
(d) a bolt thread that is helically formed around an external surface of a top region of the cylindrical inner core, wherein a pitch of the bolt thread is smaller than a pitch of the screw thread;
(e) a pointed bottom end that is configured to be rotated into and penetrate a solid substrate; and
(f) a top end that includes a bit receptor, which is configured to receive a correspondingly dimensioned screwdriver bit.

14. The screw fastener of claim 13, wherein the first circular flange includes a top surface and a bottom surface, wherein the bottom surface of the first circular flange includes a plurality of locking nibs that protrude from the bottom surface.

15. The screw fastener of claim 14, wherein each of the locking nibs exhibits a hemispherical shape.

16. The screw fastener of claim 13, wherein the bolt thread includes at least 2× a number of threads within a defined length than a number of threads of the screw thread over the defined length.

17. The screw fastener of claim 13, wherein the bit receptor is a hexalobular drive receptor.

18. The screw fastener of claim 13, which further includes a nut with an attached washer piece that is adapted to be rotated around and secured to the top region of the screw fastener.

19. The screw fastener of claim 13, wherein (i) a minor diameter of the bolt thread is smaller than a minor diameter of the screw thread and/or (ii) a major diameter of the bolt thread is smaller than a major diameter of the screw thread.

20. The screw fastener of claim 1, wherein (i) a minor diameter of the bolt thread is greater than a minor diameter of the screw thread and/or (ii) a major diameter of the bolt thread is greater than a major diameter of the screw thread.
